(19) United States
(12) Patent Application Publication
(10) Pub. No.: US 2004/0105174 A1
(43) Pub. Date: Jun. 3, 2004

(54) Fine-tuning structure of sensing element

(76) Inventor: Chien-Liang Yeh, Hsinchu (TW)

Correspondence Address: Raymond Sun, 12420 Woodhall Way, Tustin, CA, 92782, US

(21) Appl. No.: 10/308,726

(22) Filed: Dec. 2, 2002

(51) Int. Cl. G02B 26/00; G02B 7/02

(52) U.S. Cl. 359/811

(57) ABSTRACT

A fine-tuning structure of sensing element includes: a circuit board, on which sensing element is fixed and arranged; a lens set, which is bolted together with the said circuit board by bolt; it is characterized: an elastic element is arranged between the circuit board and the lens set; by the elastic element, there is an elastic expanding-and-contracting force provided between the circuit board and the lens set and, through the difference of depth for the bolt being bolted into the lens set, the distance between the sensing element and the lens and the obliqueness of the sensing element may be fine-tuned.

### 1. FIELD OF THE INVENTION

The invention relates to a fine-tuning structure of sensing element, especially to a fine-tuning structure that is simple, easily manufactured, adjusted with simple quick method, and has double functions of fine-tuning; it is characterized: an elastic element is arranged between the circuit board and the lens set; by the elastic element, there is an elastic expanding-and-contracting force provided between the circuit board and the lens set; through the difference of depth for the bolt being bolted into the lens set, the distance between the sensing element and the lens and the obliqueness of the sensing element may be fine-tuned.

### 2. BACKGROUND OF THE INVENTION

Please refer to FIG. 1, which is a cross-sectional view of the optical chassis 10 of an optical scanner according to prior arts, and by which the motion principle of the optical chassis 10 is briefly described: the optical chassis 10 includes a hollow casing 11, at appropriate position of upper side surface of which a light source 12 is arranged; from the light source 12, a light is emitted toward the document (not shown in the figure) placed on a glass 19; after the reflected light entering the casing 11 of the optical chassis 10 and through being reflected by the reflective mirrors 13, 14, 15, the light is focused by the lens set 16 and formed an image on the sensing element; the scanned image data is converted into electronic signal by the sensing element 17; accordingly, it is known that an optimal distance must be kept between the lens set 16 and the sensing element 17, such that the image can thereby be focused accurately on the sensing element 17.

For the larger model of the said traditional scanner, most of them make the sensing element fixed and arranged on the circuit board 18 and, because the internal space of the scanner is big, the optical path between the lens set 16 and the sensing element 17 is long and the focus length is deep and long and, since the sensing element 17 is fixed and arranged on the circuit board 18, so the position of the lens set 16 may be adjusted to pick up a needed image.

However, the said method is only adapted for the traditional scanner with long optical path, while the entire volume of the optical chassis must be shrunk following to the size of the scanner being reduced, such that the optical path of the lens set 16 and the sensing element 16 must be shortened, so is the focusing length; that is, since the distance between the lens set 16 and the sensing element 17 is shortened, so the focusing point must be adjusted precisely, but this adjustment is difficult and time consuming.

Meanwhile, please refer to FIG. 2A and FIG. 2B, which is a fixing method for lens set 16. The characteristic of this structure is that the sensing element 17 is fixed on the circuit board 18, which is then bolted together with the lens set 16 by a bolt 20. The circuit board 18 is arranged with a long hole 182, by which the upper-and-lower down position of the circuit board 18 may be adjusted. However, the prior art still unable to adjust the relative distance between the sensing element 17 and the lens set 16. Same as the traditional method, the lens set 16 must be adjusted.

### SUMMARY OF THE INVENTION

Therefore, in order to overcome the shortcomings of the said prior arts, the main objective of the invention is to provide a fine-tuning structure of sensing element, of which the characteristic is to arrange an elastic element between the circuit board and the lens set; by the elastic element, there is an elastic expanding-and-contracting force provided between the circuit board and the lens set and, through the difference of depth for the bolt being bolted into the lens set, the distance between the sensing element and the lens and the obliqueness of the sensing element may be fine-tuned.

For your esteemed reviewing committee to further understand the operational principle and the other function in a more clear way, a detailed description in cooperation with corresponding drawings are presented as follows.

### BRIEF DESCRIPTION OF THE DRAWINGS

FIG. 1 is an illustration of the light transporting route of the prior optical chassis.

FIG. 2A is a cross-sectional view for the assembly of a circuit board and a lens set according to the prior arts.

FIG. 2B is a front view for the assembly of a circuit board and a lens set according to the prior arts.

FIG. 3 is a cross-sectional view in vertical direction for the first preferable embodiment according to the invention.

FIG. 4 is a 3D separation view for the preferable embodiment shown in FIG. 3.

FIG. 5 is a cross-sectional view in vertical direction for another preferable embodiment according to the invention.

FIG. 6 is a 3D separation view for the preferable embodiment shown in FIG. 5.

FIG. 7A is a motion illustration when the embodiment of FIG. 3 is adapted for adjusting the obliqueness of the sensing element.

FIG. 7B is an A-A view for FIG. 7.

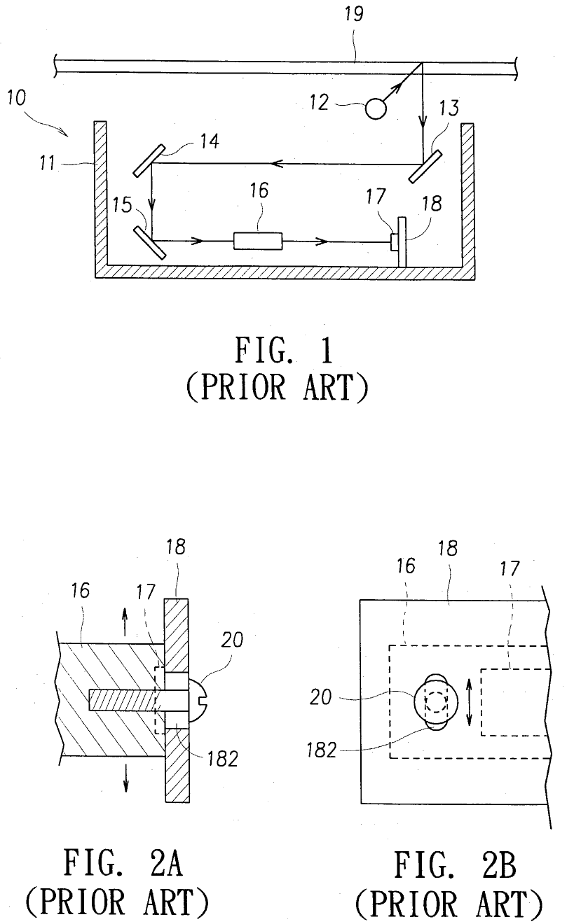

### DETAILED DESCRIPTION OF THE INVENTION

A detailed structure in matching with the corresponding drawings and its connection relationship are presented as the following for facilitating your esteemed reviewing members in understanding the present invention.

The other objective and detailed structure of the invention will be further clear through following detailed description. Of course, it is allowable for some differences for the invention to be applied in other cases but, in this application, the selected embodiments will be described in more detail, and their structures will be illustrated in the attached figures, such that the technical contents of the invention may be disclosed in a more clear way, but the structures, of the selected embodiments, illustrated in this invention are only for description, not the limitation for this patent application.

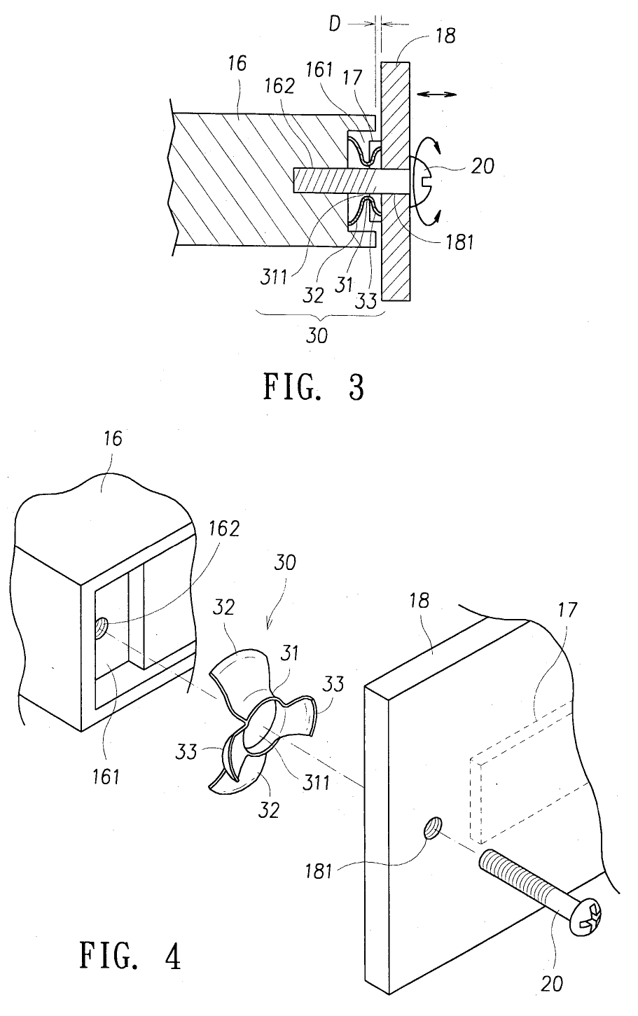

Please refer to FIG. 3 and FIG. 4, which illustrate a fine-tuning structure of a sensing element, wherein the sensing element 17 may be a charge coupled device (abbreviated as CCD) or a CMOS sensing element. The sensing element 17 is fixed and arranged on the circuit board 18, which is bolted together on the lens set 16 by the bolt 20, and it is characterized: an arc elastic piece approximately belonged to sandglass shape is arranged at a position between the lens set 16 and the circuit board 18 and is corresponding to the bolt 20. The arc elastic structure 30 has a waist 31 of smaller diameter. The waist 31 has an internal penetration hole 311 available for being penetrated by the bolt 20. At two axial sides of the waist 31, plural arc pieces 32, 33 are extended out from the arc edge of the waist 31. A recession 161 is arranged at the lens set 16 at a position corresponding to the arc elastic structure 30, which is accommodated by this recession 161. A bolt hole 162 is arranged in the recession 161 at a position corresponding to the bolt hole 181 of the circuit board 18 and the penetration hole 311 of the arc elastic structure 30. Thereby, after the bolt 20 being bolted into the bolt hole 181, penetration hole 311, and bolt hole 162, the lens set 16 and the circuit board 18 may be integrated as a complete entirety in outer appearance. By making the arc pieces 32, 33 of the arc elastic structure 30 respectively abutted against the corresponding faces of the recession 161 of the lens set 16 and the circuit board 18, it may provide an elastic expanding-and-contracting force between the lens set 16 and the circuit board 18.

Accordingly, it may finely tune the distance D between the sensing element 17 and the lens set 16 by adjusting the different depths of the bolt 20 being bolted into the lens set 16, such that the objective of accurate focusing is fulfilled. Of course, the invention may also be cooperated with this fine-tuning function of lens set 16 to reach a more delicate quality of image adjustment; furthermore, pressing the circuit board 18 by the elastic force of the arc elastic structure 30, it can avoid the circuit board 18 from loosening off.

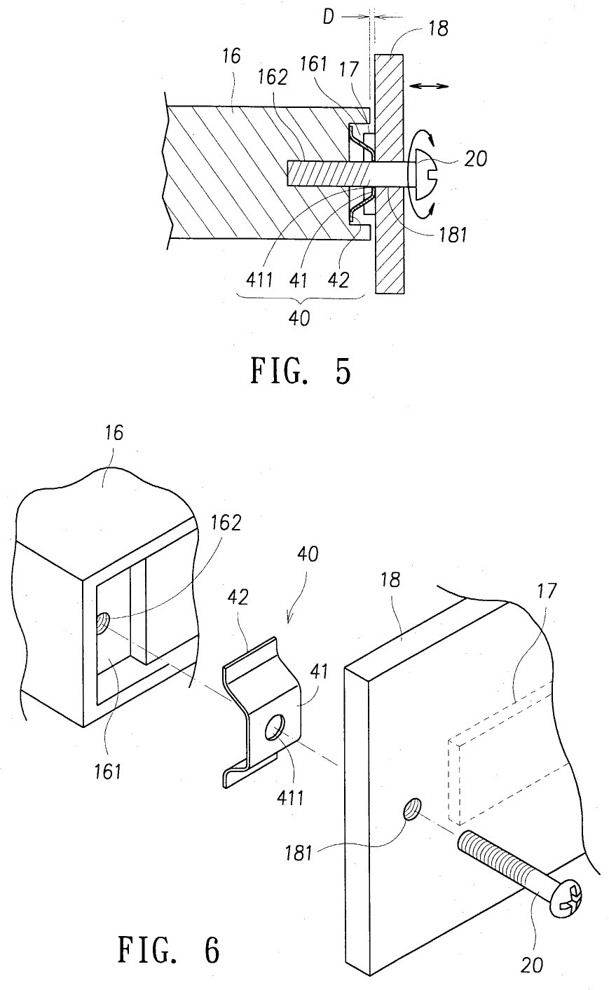

Please refer to FIG. 5 and FIG. 6, which illustrate another embodiment of the invention, which is same as that shown in FIG. 3 and FIG. 4. This embodiment is also to fix and arrange a sensing element 17 on a circuit board 18, which is again bolted on a lens set 16 by the bolt 20. This embodiment is characterized: an elastic body 40 formed approximately as a trapezoid is arranged between the lens set 16 and the circuit board 18 at the position corresponding to the bolt 20, wherein the elastic body 40 has a top part 41 and a bottom part 42 that is obliquely extended from the two sides of the top part 41, which has an internal penetration hole 411 available for the bolt 20 to penetrate through. A recession 161 is arranged at the lens set 16 at a position corresponding to where the elastic body 40 is arranged. The elastic body 40 is accommodated in the recession 161, and a bolt hole 162 is arranged in the recession 161 at a position corresponding to the bolt hole 181 of the circuit board 18 and the penetration hole 411 of the elastic body 40. Thereby, after the bolt 20 being bolted into the bolt hole 181, penetration hole 411, and bolt hole 162, the lens set 16 and the circuit board 18 may be integrated as a complete entirety in outer appearance. By making the top part 41, the bottom part 42 of the elastic body 40 respectively abutted against the corresponding faces of the recession 161 of the lens set 16 and the circuit board 18, it may provide an elastic expanding-and-contracting force between the lens set 16 and the circuit board 18.

Accordingly, it may finely tune the distance D between the sensing element 17 and the lens set 16 by adjusting the different depths of the bolt 20 being bolted into the lens set 16, such that the objective of accurate focusing is fulfilled. Of course, the invention may also be cooperated with this fine-tuning function of lens set 16 to reach a more delicate quality of image adjustment; furthermore, pressing the circuit board 18 by the elastic force of the elastic body 40, it can avoid the circuit board 18 from loosening off.

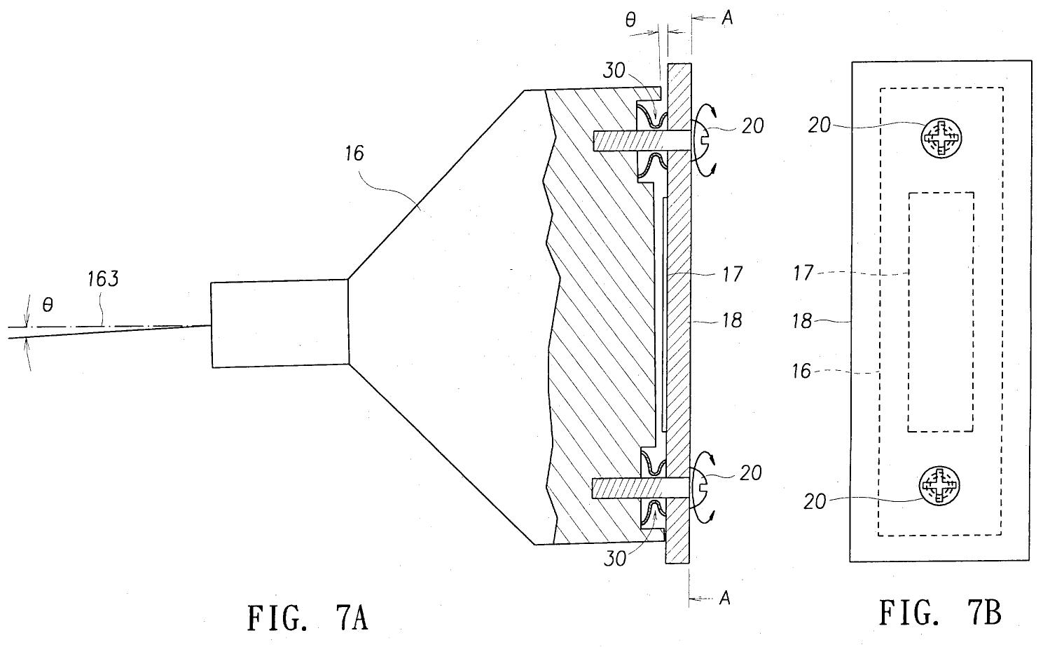

Again, please refer to FIG. 7A and FIG. 7B, which are the motion illustrations for finely tuning the obliqueness of the sensing element 17, wherein the arc elastic piece structure 30 shown in FIG. 3 and FIG. 4 is taken as example. The bolt 20 is commonly bolted in each two sides for the lens set 16 and the circuit board 18 correspondingly. Since the corresponding faces for the circuit board 18 and the sensing element 17 are unable to be parallel to each other, so the sensing element 17 may be caused to be oblique because of the obliqueness of the circuit board 18 itself or the depth unevenness of the bolted bolt 20, such that an oblique angle Θ is existed between the emitted light axis 161 of the lens set 16 and the axial center of the sensing element 17 to thereby influence the image quality. Since the arc elastic structure 30 is arranged between the lens set 16 and the circuit board 18, so any kind of the obliqueness of the sensing element 17 such as vertical, horizontal, and diagonal obliqueness may be finely tuned for eliminating the oblique angle Θ, and its adjusting method is simple and quick. Of course, the elastic body 40 of the elastic element of the embodiment shown in FIG. 5 and FIG. 6 may also reach the function of this obliqueness adjustment described thereinbefore, so it is still belonged to the field of the technical means of the invention, and its detail is not repetitiously described herein.

One emphasis must be addressed: the said arc elastic structure 30 and elastic body 40 are only two preferable embodiments of the elastic element according to the invention, so any abutting plane provided for the lens set 16 and the circuit board 18 such as spring or elastic piece, etc. having appropriate elasticity to abut the lens set 16 and the circuit board 18 and any structure device capable of providing appropriate expanding-and-contracting elasticity are all belonged to the embodying field of the elastic element of the invention. Although the technical means that adopts the elastic element as a structural device for adjusting elasticity looks simple, its application has never seen in finely tuning the sensing element of a scanner so far. The invention, by a simple mechanism, makes the problem that exists long time in the common industry of scanner producer—the fine adjustment of the focus and the obliqueness of the sensing element—be solved easily.

In summary, a fine-tuning structure of sensing element may finely adjust the relative distance between the sensing element and the lens set by applying the elastic expanding-and-contracting force possessed by the elastic element provided between the lens and the circuit board according to the different depths of the bolt being bolted into the lens set, so an accurate focusing objective may be achieved. Furthermore, by arranging the elastic element in the corresponding two sides of the sensing element, it may finely adjust the sensing element without being oblique, so only one device may be applied to achieve the double objectives of finely adjusting the focus and the obliqueness of the sensing element and, by making the elastic force of the elastic element abutted against the circuit board, it can avoid the circuit board from loosening off, besides its structure is simple, easily manufactured, and the fine-tuning method is simple and quick, so the invention apparently possesses all the industrial availability and the progressiveness. However, the description and the illustration disclosed thereinbefore are only the preferable embodiments according to the invention and, of course, they are not used to limit the really practicing field of the invention, so any kind of variation that is made according to the structural characteristic and the function described in the above embodiments and the following patent application claims such as the variation of value and the replacement of equivalent element is all belonged to the fields of the invention.

In addition, the application of the invention has never seen in any public occasion or journal, so the invention deeply possesses the novelty of the merits of a patent-industrial availability, innovation, and progressiveness. According to the patent law, this novel invention is applied as a new patent so, please your esteem members of reviewing committee review this application as favorable as possible, and grant it as a normal paten in the near future.

What is claimed is:

1. A fine-tuning structure of sensing element comprising:
a circuit board, on which sensing element is fixed and arranged;
a lens set, which is bolted together with the said circuit board by bolt;
Where in the elastic element is arranged between the circuit board and the lens set; by the elastic element, there is an elastic expanding-and-contracting force provided between the circuit board and the lens set and, through the difference of depth for the bolt being bolted into the lens set, the distance between the sensing element and the lens and the obliqueness of the sensing element may be fine-tuned.

2. The fine-tuning structure of sensing element according to claim 1, wherein the elastic element is arranged at the bolt that bolts the lens set and the circuit board together, and the elastic element has a penetration hole available for the bolt to penetrate through, and there is a recession arranged at the lens set at the arranging position corresponding to the elastic element and, by accommodating the elastic element in the recession and bolting the bolt into the bolt hole of the circuit board, the penetration hole of the elastic element, and the bolt hole of the lens set, the lens set and the circuit board is combined to a complete entirety in outer appearance.

3. The fine-tuning structure of sensing element according to claim 1, wherein the elastic element is an arc elastic structure formed approximately as a sandglass, and the arc elastic structure has a waist with smaller diameter, and the waist has a penetration hole, and plural arc pieces at the axial two sides of the waist are extended from the arc edges of the waist and, by abutting the arc pieces respectively against the lens set and the circuit board, there is elastic force provided between the lens set and the circuit board.

4. The fine-tuning structure of sensing element according to claim 1, wherein the elastic element is an elastic body formed approximately as a trapezoid, and the elastic body has a top part and a bottom part that is obliquely extended down from the two sides of the top part, and the top part has a penetration hole, and the top part and the bottom part of the elastic body are respectively abutted against the circuit board and the lens set, such that the elastic expanding-and-contracting force is provided between the lens set and the circuit board.
